(19) United States
(12) Patent Application Publication
(10) Pub. No.: US 2020/0191946 A1
(43) Pub. Date: Jun. 18, 2020

(54) METHODS AND SYSTEMS FOR CONTROLLING WEATHER RADAR AND ELECTRO-OPTICAL AND IMAGING SYSTEMS OF SEARCH AND RESCUE VEHICLES

(71) Applicant: Honeywell International Inc., Morris Plains, NJ (US)

(72) Inventors: Niranjan KALYANDURG, Bangalore (IN); Sunit Kumar SAXENA, Bangalore (IN); Charan EBSV, Hyderabad (IN); Yogananda Vasudev JEPPU, Bangalore (IN)

(73) Assignee: Honeywell International Inc.

(21) Appl. No.: 16/223,747

(22) Filed: Dec. 18, 2018

(51) Int. Cl. G01S 13/86; G01S 13/95; G01S 7/06

(52) U.S. Cl. CPC G01S 13/867; G01S 7/064; G01S 13/95; G01S 13/865

(57) ABSTRACT

Disclosed are methods, systems, and non-transitory computer-readable medium for detecting and confirming objects using a radar system and an electro-optical and imaging system of a vehicle. For instance, the method may include obtaining volumetric radar data, the volumetric radar data being produced by the radar system of the vehicle for zones of a scanned area; analyzing the volumetric radar data to detect objects in a subset of zones from among the zones of the scanned area; controlling the electro-optical and imaging system of the vehicle to examine the subset of zones to identify and confirm the presence of the detected objects in one or more zones of the subset of zones; receiving a confirmation that a detected object of the detected objects is present in the one or more zones of the subset of zones; and performing an action to update a vehicle system in response to receiving the confirmation.

### TECHNICAL FIELD

Various embodiments of the present disclosure relate generally to search and rescue (S&R) systems and, more particularly, to methods and systems for controlling weather radar, searchlight, and imaging systems of search and rescue vehicles.

### BACKGROUND

S&R missions may face significant challenges when searching for relevant objects, such as people, wreckage, or other vehicles. Moreover, searching may be even more difficult during poor visibility conditions or when searching in a water environment. When searching in a water environment, a search operation may focus on detecting small boats, life rafts, or floating personnel as quickly as possible. This may be even more important during inclement weather, choppy waves, and high wind conditions.

S&R personnel may employ devices, such as camera systems and searchlight systems. The camera systems may be optimized for high probability detection of small objects at long range with a wide field of view. Searchlight systems may supplement the camera systems for shorter range searching. Furthermore, searchlights may be coupled with a soft-red filter lighting to coordinate winching rescue operations. However, searchlights, cameras, and LIDAR systems (collectively “electro-optical and imaging systems”) may have a limited range and a more limited range in bad weather conditions because of poor visibility. Typically, the limited range extends to about one kilometer and the searchlight may have a beam spread of ten to fifteen degrees. Usually, in order to scan wider areas, searchlights may be manually pointed to a region of interest. Therefore, S&R missions are limited in their capability to search large geographic areas.

In typical S&R missions, such as for the Malaysia Airlines Flight MH370, search speed may play a critical role. For instance, as time passes and the ocean drifts, floating articles may drift away from a splashdown point. This drift away may further increase the difficulty of the S&R mission, as it increases a potential search area from any assumed splashdown point. Currently, significant time is spent in searching and locating any floating objects, which may delay the response time of a search & rescue operation personnel.

Therefore, methods or systems that increase the search volume of a search vehicle and/or reduce the search time of a given search volume for the vehicle can reduce the response time in S&R missions.

Furthermore, S&R missions may include a plurality of vehicles that may not have similar capabilities (e.g., a helicopter and a drone both search an area where the drone does not have the same capabilities as the helicopter). However, even if the vehicles are able to communicate, efficient deployment of vehicles in the S&R mission needs to be improved.

The present disclosure is directed to overcoming one or more of these above-referenced challenges.

### SUMMARY OF THE DISCLOSURE

According to certain aspects of the disclosure, systems and methods are disclosed for detecting and confirming objects using a radar system and an electro-optical and imaging system of a vehicle.

For instance, a method may include: obtaining volumetric radar data, the volumetric radar data being produced by the radar system of the vehicle for zones of a scanned area; analyzing the volumetric radar data to detect objects in a subset of zones from among the zones of the scanned area; controlling the electro-optical and imaging system of the vehicle to examine the subset of zones to identify and confirm the presence of the detected objects in one or more zones of the subset of zones; receiving a confirmation that a detected object of the detected objects is present in the one or more zones of the subset of zones; and performing an action to update a vehicle system in response to receiving the confirmation.

A system may include: a memory storing instructions; and a processor executing the instructions to perform a process. The process may include: obtaining volumetric radar data, the volumetric radar data being produced by the radar system of the vehicle for zones of a scanned area; analyzing the volumetric radar data to detect objects in a subset of zones from among the zones of the scanned area; controlling the electro-optical and imaging system of the vehicle to examine the subset of zones to identify and confirm the presence of the detected objects in one or more zones of the subset of zones; receiving a confirmation that a detected object of the detected objects is present in the one or more zones of the subset of zones; and performing an action to update a vehicle system in response to receiving the confirmation.

A non-transitory computer-readable medium may store instructions that, when executed by a processor, cause the processor to perform a method for detecting and confirming objects using a radar system and a searchlight system of a vehicle. The method may include: obtaining volumetric radar data, the volumetric radar data being produced by the radar system of the vehicle for zones of a scanned area; analyzing the volumetric radar data to detect objects in a subset of zones from among the zones of the scanned area; controlling the electro-optical and imaging system of the vehicle to examine the subset of zones to identify and confirm the presence of the detected objects in one or more zones of the subset of zones; receiving a confirmation that a detected object of the detected objects is present in the one or more zones of the subset of zones; and performing an action to update a vehicle system in response to receiving the confirmation.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system environment for detecting and confirming objects using a radar system and an electro-optical and imaging system of a vehicle, according to one or more embodiments.

FIG. 2 depicts an exemplary block diagram of a system for detecting and confirming objects using a radar system and an electro-optical and imaging system of a vehicle, according to one or more embodiments.

FIG. 3 depicts a flowchart for detecting and confirming objects using a radar system and an electro-optical and imaging system of a vehicle, according to one or more embodiments.

FIG. 4 depicts an example system configured to execute techniques presented herein.

### DETAILED DESCRIPTION OF EMBODIMENTS

Various embodiments of the present disclosure relate generally to search and rescue (S&R) systems and, more particularly, to methods and systems for controlling weather radar, searchlight, and imaging systems of search and rescue vehicles.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

While this disclosure describes the systems and methods with reference to aircraft (e.g., S&R aircraft), it should be appreciated that the present systems and methods are applicable to management of vehicles with weather radar, searchlight systems, and camera systems, including those of drones, automobiles, ships, or any other autonomous and/or Internet-connected vehicle. Furthermore, in this disclosure, unless context indicates otherwise, an electro-optical and imaging system may include one or a combination of a searchlight system, a camera system, or a LIDAR system.

In general, the present disclosure is directed to control of on-board systems of a S&R vehicle. Most S&R vehicles, such as helicopters, are equipped with built-in weather radars to enable detection of weather hazards for safety of flight. As discussed below, a S&R vehicle may control a weather radar and detect objects based on weather radar data. Most S&R vehicles also have an electro-optical and imaging system (e.g., with a searchlight and/or camera systems) that is manually operated or semi-automated with image processing systems. As discussed below, the S&R vehicle may control an electro-optical and imaging system to inspect the detected object, confirm the presence of the detected object, and perform different actions based on the confirmation of the detected object. For instance, while search lights may have ten to fifteen degrees of horizontal view, a weather radar may have +/−60 degrees of horizontal scan capability. Therefore, the weather radar may provide 120 degrees frontal coverage area. This may drastically increase a coverage area compared to that of searchlight.

Moreover, detecting objects with the weather radar may also increase the coverage area of a S&R mission by sharing coordinates of the detected object to other S&R vehicles. Therefore, the use of the weather radar and sharing of the detected objects location, may enable faster, more efficient, and more accurate responses.

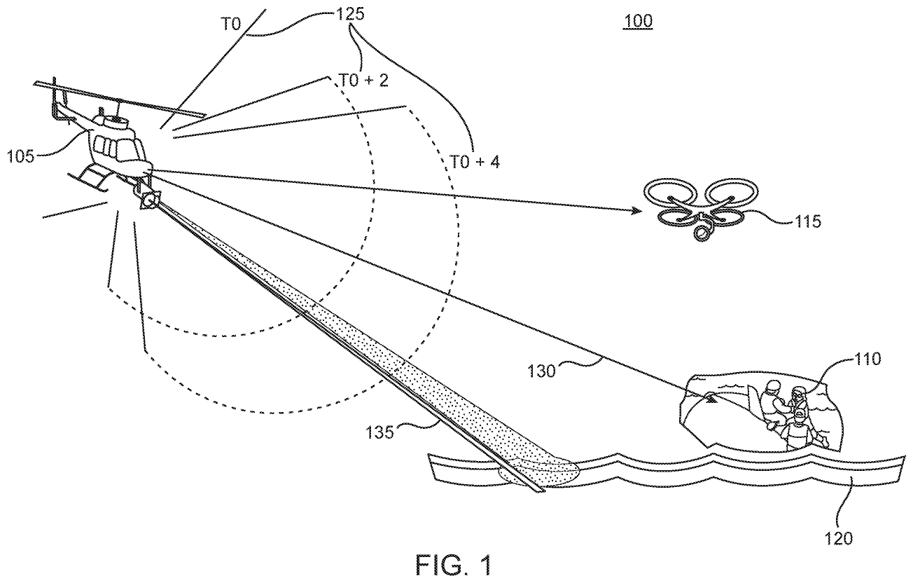

As shown in FIG. 1, FIG. 1 depicts an exemplary system environment for detecting and confirming objects using a radar system and an electro-optical and imaging system of a vehicle, according to one or more embodiments. The system environment 100 may include a plurality of S&R vehicles, including primary vehicle 105 and secondary vehicle 115. The S&R vehicles may be searching in search area 120 for object 110 that may be a person, a raft, another vehicle, or wreckage, on land or floating at sea.

S&R vehicles may use one or more sub-systems to locate the object 110. For instance, primary vehicle 105 (which may be a helicopter) may have several different systems on board, such as a weather radar, a searchlight, a camera system, and a LIDAR system. For instance, the weather radar may transmit radar signals to the environment in accordance with control signals from a controller, and the weather radar may receive reflections of the transmitted radar signals from the environment and process the reflections as weather radar data. The received weather radar data may be received and stored as time slices 125. Moreover, the searchlight may output a beam of light 130, in accordance with control signals from the controller to illuminate a segment of the search area 120. Further, the LIDAR system may transmit pulsed laser 135, in accordance with control signals from the controller to illuminate a segment of the search area (either the same as the searchlight system or not), and receive reflected pulsed light to detect distance and/or to create 3D representations of the target/environment.

Primary vehicle 105 and secondary vehicle 115 may communicate back and forth by various methods, either directly (e.g., wireless ad hoc Wi-Fi network or by radio) or indirectly by satellite or other communications through a central network (e.g., the internet or a S&R platform in command of the S&R mission). Communication between primary vehicle 105 and secondary vehicle 115 may include images (snapshots and continuously updated views), audio communication, locations etc. Communication between the secondary vehicle 115 and the object detected may include audio instructions, sensor feedback, health metrics, video, etc.

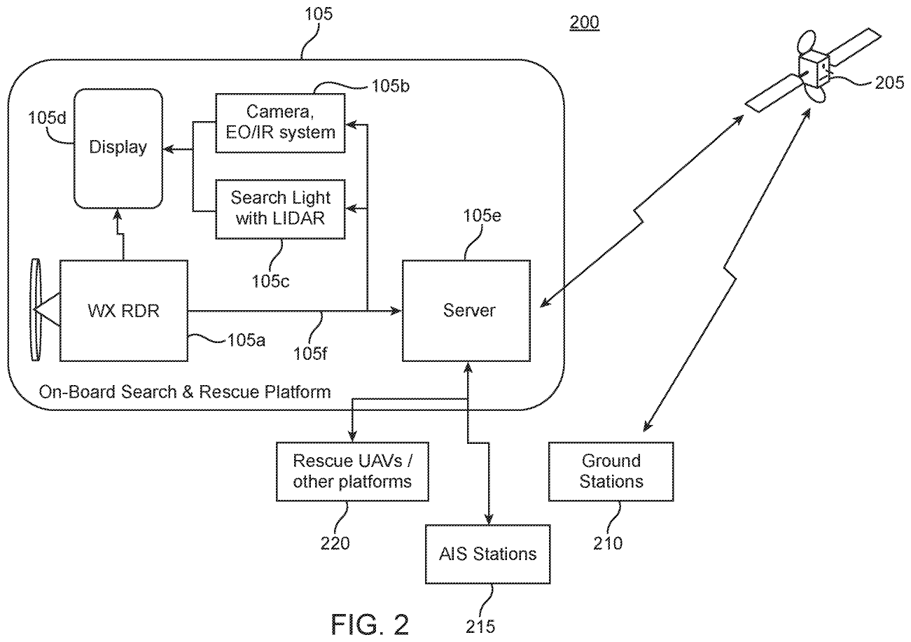

FIG. 2 depicts an exemplary block diagram of a system for detecting and confirming objects using a radar system and an electro-optical and imaging system of a vehicle, according to one or more embodiments. As shown in FIG. 2, system 200 may include: the primary vehicle 105, a satellite communication system 205 with ground stations 210, secondary vehicles 220 (which may include the secondary vehicle 115 of FIG. 1), and automatic identification system (AIS) stations 215. Specifically, the primary vehicle 105 may include an on-board S&R platform that includes a weather (WX) radar 105a, an electro-optical and imaging system (which may include an electro-optical and infrared camera (EO/IR) system 105b and/or a searchlight with LIDAR system 105c), a display 105d, a server 105e, and a databus 105f.

The weather radar 105a, the camera system 105b, and the searchlight system 105c (collectively “sensors”) may be controlled by a controller, as discussed above. The controller may be an independent computer system on-board the primary vehicle 105 or it may be the server 105e. The sensors may be connected to the controller and the server 105e.

The controller or the sensors may be connected to the display 105d and sensor data may be transmitted (from either the controller or the sensors) to the display 105d to be displayed (either automatically, in response to control signals from the controller, or the data may be transmitted by the controller to the display 105d).

The sensors and/or controller may transmit data to the server 105e (if the server 105e is not the controller), and the server 105e may (in response to instructions from the controller) transmit data to other platforms, such as secondary vehicles 220, AIS stations 215, and ground stations 210 (via satellite communication system 205). Secondary vehicles may include one or more of unmanned aerial vehicles (UAVs), drones, helicopters, ships, and airplanes. Server 105e may transmit data to the AIS stations 215 by an aircraft communications addressing and reporting system (ACARS) message and to ground stations 210 by a SATCOM medium.

To detect objects, the weather radar 105a may be controlled to operate in a target detection mode, in accordance with weather radar control signals from the controller. Usually weather radars are pointed towards the sky where weather (e.g., moisture or particles in clouds and/or rain droplets) may be detected by the weather radar. Instead, weather radar 105a, in the target detection mode, may be controlled to point downward and transmit phase-coded high-bandwidth waveforms to detect objects in areas of interest (like search area 120 of FIG. 1). The weather radar 105a may distinguish between closely spaced targets by using sea clutter reduction techniques and target enhancement techniques. The weather radar 105a may receive reflection signals and store the reflection signals as target return data in a volumetric buffer (e.g., a memory) of the weather radar 105a, and the weather radar 105a may detect objects from the target return data (as opposed to water, waves, land, or a general foreground/background environment).

Time slices (like time slices 125 in FIG. 1) of target return data may be stored in the volumetric buffer of the weather radar 105a, and may be analyzed to provide information on moving objects. For instance, a scanned area of the weather radar 105a may be divided into zones based on ranges and azimuth angles. The range and azimuth angle may be based on the reflection data that corresponds to a portion of the phase-coded high-bandwidth waveforms that are transmitted by the weather radar 105a. The zones with detected objects may be determined to be areas of interest by either the weather radar 105a or the controller. Those detected objects may be tracked by either the weather radar 105a or the controller. The tracking may use the time slices to determine how the objects (like object 110) are moving between each time step of the time slices (e.g., the object is farther away from the primary vehicle 105 and farther to the right of the primary vehicle 105 at the next time step). For instance, the tracking of the detected objects may be for a period of time that includes at least two time slices of the time slices, and the weather radar 105a may estimate a movement direction and speed of the detected objects based on changes in the ranges and azimuths angles for the detected objects and the relative location, heading, and speed of the primary vehicle 105. Furthermore, the location (e.g., latitude and longitude) may be determined either by the weather radar 105a or the controller based on the range and azimuth angle and a location of the primary vehicle 105.

Weather radar 105a (or the controller, or based on instructions from the controller) may transmit radar images to the display 105d to be displayed. The displayed radar images may include a snapshot of one moment of the target return data, a continuously updating view of the target return data, and/or a track of detected objects overlaid with either the snapshot or the continuously updating view. A user (e.g., pilot) of the primary vehicle 105 may select regions by a user input for further searching based on the displayed radar images. The primary vehicle 105 may increase the 120 degree scan limit of the weather radar 105a by yaw maneuvering the primary vehicle 105.

The searchlight system 105c may be controlled to operate in a target examination and confirmation mode, in accordance with searchlight control signals from the controller. In the target examination and confirmation mode, the searchlight system 105c may be controlled to search one or more areas of interest that have a detected object, in response to a new detected object or when instructed by a user input. For instance, the searchlight system 105c may be automatically controlled to examine the closest area of interest from the primary vehicle 105 by shining a beam of light at a location of the area of interest. The searchlight system 105c may continuously shine the beam of light at the location until instructed otherwise by a user input, or the searchlight system 105c may proceed to other areas of interest that are farther away from the primary vehicle 105 after a predetermined period of time. Alternatively, the searchlight system 105c may be controlled to examine an area that has a higher likelihood that a detected object is relevant to the search based on size or movement pattern. As discussed above, the user may select regions for further searching from the displayed radar images, and the controller may control the searchlight system 105c in response to that user input. Specifically, the searchlight system 105c may examine each region indicated by the selection in the order selected by the user or the searchlight system may examine each region indicated by the selection in order from closest to farthest away from the primary vehicle 105. The searchlight system 105c may be controlled to track the detected object based on the estimate movement direction and speed of the detected object. The user of the vehicle may input a user input to indicate that the detected object is a confirmed object, based on the user visually inspecting the area illuminated by the search light system 105c. Moreover, the LIDAR of the searchlight system 105c may examine a same area of the searchlight system 105c (at the same time or independently of the searchlight system 105c) and perform an object detecting process. The object detecting process may process LIDAR data to detect/confirm objects; or the LIDAR may transmit the LIDAR data to the controller (or server 105e) and the controller/server 105e may process the LIDAR data to detect/confirm objects.

Alternatively, the searchlight system 105c may be controlled to track the weather radar 105a. For instance, as the weather radar 105a changes its orientation from left to right (or right to left, up to down, down to up, etc.) to perform a 120 degree azimuth scan, the searchlight system 105c may also track the same sweep and/or across the same zone as the weather radar 105a.

The camera system 105b may be controlled to operate in a target examination and confirmation mode along with or separately from the searchlight system 105c, in accordance with camera control signals from the controller or the searchlight system 105c. The camera system 105b may be controlled to examine the same areas of interest that are being examined by the searchlight system 105c, or instead of the search light system 105c. The camera system 105b may have an image processing capability to process a camera image to visually detect objects or the camera system 105b may transmit data corresponding the camera image to the controller or the server 105e (if the server 105e is not the controller) so that the controller or the server 105e may process the camera image to visually detect objects (called “confirmed objects”). Based on the image processing, the camera system 105b, the controller, or the server 105e, may transmit an alert, message, and/or the camera image to the display 105d to alert a user that the confirmed object is present in the area of interest.

In addition or as an alternative to the image processing, the camera system 105b (or the controller, or based on instructions from the controller) may transmit camera images to the display 105d to be displayed. The displayed camera images may include a snapshot of the camera images (so that it is steady for a user to view), a continuously updating view of the camera image, and/or the snapshot or the continuously updating view of the camera image may be overlaid with the snapshot or the continuously updating view of the radar image (and/or the track of detected objects overlaid with either). Furthermore, the camera system 105b may generate camera images in multiple different domains, such as a first image in an electro-optical domain and a second image in an infrared domain. The user (e.g., pilot) of the primary vehicle 105 may select objects/regions of the camera image by a user input for further action based on the displayed camera images, and/or the user of the vehicle may input a user input to indicate that the detected object is a confirmed object.

In response to the detected objects being confirmed objects, the controller may perform an action to update a vehicle system. For instance, the controller may update a database or the controller may transmit a confirmed object instruction to the server 105e. The server 105e may then transmit an instruction to other vehicles, such as one or more of secondary vehicles 220, or transmit an alert or notification to an alert system on the primary vehicle 105, one of the secondary vehicles 220, or a central command that a detected object has been confirmed as a confirmed object and is relevant to the S&R mission.

The use of the weather radar 105a may increase the searchable volume by using a wider field of view (120 degrees compared with 15 degrees) and/or a farther range of detection (5 to 10 nautical miles compared with a limited range (approximately 1000 feet) of the electro-optical and imaging system (e.g., such as the searchlight system 105c). Therefore, searching operations of a S&R mission may be performed more quickly.

The use of the electro-optical and imaging system (e.g., user visual confirmation with the searchlight system 105c, the LIDAR confirmation of the object with the LIDAR, the camera confirmation with the camera system 1205b, and/or the combination of the searchlight system 105c or LIDAR and the camera system 105b) to perform examinations of the areas of interest may expedite the search of a search area and expedite a decision making process by the user of the primary vehicle 105. Therefore, a search time may be reduced for a given search area.

Moreover, radar data, camera data, LIDAR data, and/or location data may be streamed from the server 105e to secondary vehicles 220. Moreover, instructions may be transmitted from the primary vehicle 105 to one or more of the secondary vehicles 220. The radar data may include the radar images or the underlying target return data from the volumetric buffer. The camera data may include the snapshot or the continuously updated view of the camera images. The LIDAR data may include a LIDAR point cloud data with coordinates (which may include, e.g., intensity, time information, etc.) of each data point received by the LIDAR and/or processed LIDAR point cloud data, for a single moment or a range of time. The processed LIDAR point cloud data may include objects detected by the LIDAR. The processed LIDAR point cloud data may include object point clouds for the objects, and each object point cloud may have with coordinates (which may include, e.g., intensity, time information, etc.) of each data point associated with the object. Location data may include a location (e.g., latitude and longitudinal) of detected objects and/or of confirmed objects, along with an estimated movement direction and speed of the objects.

The one or more secondary vehicles 220 may be instructed to travel to one or more of the detected objects or confirmed objects to perform an action. While traveling to the one or more detected objects or confirmed objects, the one or more secondary vehicle 220 may be tracked and guided by the primary vehicle 105. The one or more secondary vehicles 220 may be instructed to travel to different detected objects or confirmed objects so that no two secondary vehicles 220 travel to the same object, for instance if two secondary vehicles 220 are not needed to travel to the same object. The action on the secondary vehicle 220 may be one or more of: (1) examine the detected object (and confirm the object by image processing on-board from an on-board camera or transmit signals back with object images or other data so that another vehicle (e.g., the primary vehicle 105) or user can confirm the object), (2) examine a confirmed object, (3) deploy usable materials in the area of the detected objects or confirmed objects, (4) communicate with the detected object using audio instructions, sensor feedback, health metrics, video, etc., and/or (5) transmit the object image, results of the communication with the detected object (e.g., audio feedback from detected object, sensor feedback, health metrics feedback), and/or location information back to the primary vehicle 105. The object image from secondary vehicle 220 may be over laid or displayed on the display 105d of the primary vehicle 105.

The LIDAR system of the searchlight system 105c may be used to scan or determine a distance between the primary vehicle 105 and the detected objects or the confirmed objects. For instance, the LIDAR system range or scan the same area of interest the searchlight system 105c or the camera system 105b, to provide additional ranging information (e.g., based on the LIDAR data). The LIDAR data may be transmitted to the display 105d to be displayed. The displayed LIDAR data may be used for generating auto-tilting commands for the weather radar 105a, the searchlight system 105c, or the camera system 105b. Also, the LIDAR data may be used for augmenting the range measurements made by the weather radar 105a. Furthermore, the LIDAR data may be used to guide a secondary vehicle of the secondary vehicles 220 to a detected object/confirmed object by comparing the position of the secondary vehicle with respect to the detected object/confirmed object.

The primary vehicle 105 may also transmit and receive the target information to/from ships (of other secondary vehicles 220) and ground installations 210 using AIS stations 215 and satellite communications system 205 (by way of server 105e). For instance, on receiving the target information from a ship, the primary vehicle 105 may travel to and search a given area; if the primary vehicle 105 detects an object and confirms the object (either directly or indirectly by secondary vehicle 220), the primary vehicle 105 may transmit target information to the ship, which may go to a specific location based on the received target information.

Therefore, the resources of the S&R mission can be efficiently deployed with the connected framework between the primary vehicle 105 and the secondary vehicles 220. The weather radar 105a may detect objects closer to secondary vehicles 220, which may be able to examine the detected object faster than the primary vehicle 105. Moreover, of a plurality of vehicles, only one or a few may have a weather radar, and these vehicles may coordinate the other vehicles to examine detected objects. Therefore, search time for a given search area can be decreased by efficiently using vehicles, even if the vehicles have different levels of capability.

Moreover, the primary vehicle 105 may receive information, e.g., from one of the secondary vehicles 220, that an object has been detected at a location. Alternatively, the primary vehicle 105 may detect the object at the location using the electro-optical and imaging system (e.g., the LIDAR). The controller of the primary vehicle 105 may control the weather radar 105a to examine the location indicated by the information/electro-optical and imaging system, either automatically or based on a user input. The weather radar 105a may, in the target detection mode, be controlled to point downward and transmit phase-coded high-bandwidth waveforms to detect objects in the location indicted by the information. The weather radar 105a may distinguish between closely spaced targets by using the sea clutter reduction techniques and the target enhancement techniques, discussed above. The weather radar 105a may receive reflection signals and store the reflection signals as the target return data in the volumetric buffer (e.g., the memory) of the weather radar 105a. The controller/weather radar 105a may confirm the presence of the objects from the target return data. The controller may then perform the action to update the vehicle system. For instance, the controller may update the database or the controller may transmit the confirmed object instruction to the server 105e. The server 105e may then transmit an instruction to other vehicles, such as one or more of the secondary vehicles 220, or transmit the alert or notification to the alert system on the primary vehicle 105, one of the secondary vehicles 220, or the central command that a detected object has been confirmed as a confirmed object and is relevant to the S&R mission.

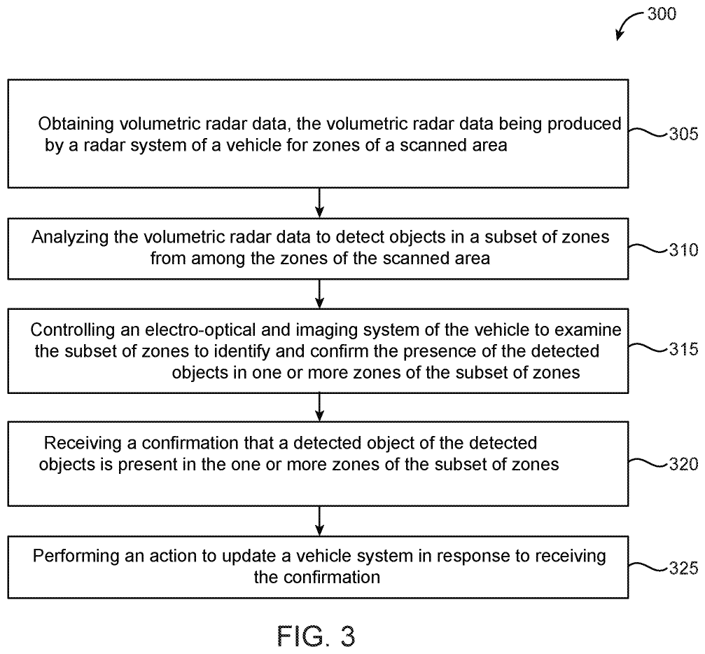

FIG. 3 depicts a flowchart for detecting and confirming objects using a radar system and an electro-optical and imaging system of a vehicle, according to one or more embodiments. As shown in FIG. 3, a flowchart of a method 300 for detecting and confirming objects using a radar system and a searchlight system of a vehicle, may include, at block 305, obtaining volumetric radar data, the volumetric radar data being produced by the radar system of the vehicle for zones of a scanned area. At block 310, method 300 may include analyzing the volumetric radar data to detect objects in a subset of zones from among the zones of the scanned area. At block 315, method 300 may include, controlling the searchlight system of the vehicle to examine the subset of zones to identify and confirm the presence of the detected objects in one or more zones of the subset of zones. At block 320, method 300 may include receiving a confirmation that a detected object of the detected objects is present in the one or more zones of the subset of zones. At block 325, method 300 may include performing an action to update a vehicle system in response to receiving the confirmation.

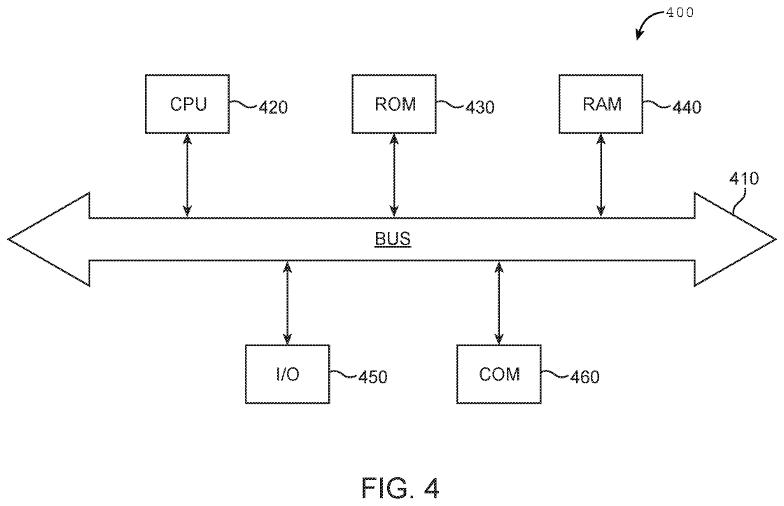

FIG. 4 depicts an example system that may execute techniques presented herein. FIG. 4 is a simplified functional block diagram of a computer that may be configured to execute techniques described herein, according to exemplary embodiments of the present disclosure. Specifically, the computer (or “platform” as it may not a be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for detecting and confirming objects using a radar system and an electro-optical and imaging system of a vehicle, comprising:
obtaining volumetric radar data, the volumetric radar data being produced by the radar system of the vehicle for zones of a scanned area;
analyzing the volumetric radar data to detect objects in a subset of zones from among the zones of the scanned area;
controlling the electro-optical and imaging system of the vehicle to examine the subset of zones to identify and confirm the presence of the detected objects in one or more zones of the subset of zones;
receiving a confirmation that a detected object of the detected objects is present in the one or more zones of the subset of zones; and
performing an action to update a vehicle system in response to receiving the confirmation.

2. The method of claim 1, wherein the volumetric radar data includes time slices of the zones of the scanned area, and the zones are based on ranges and azimuth angles of reflection signals received by the radar system.

3. The method of claim 2, wherein the analyzing the volumetric radar data to detect the detected objects in the subset of zones includes:
tracking the detected objects over a period of time that includes at least two time slices of the time slices, and
estimating a movement direction and speed of the detected objects.

4. The method of claim 1, wherein the electro-optical and imaging system includes a searchlight system, and
the controlling the electro-optical and imaging system of the vehicle to examine the subset of zones to identify and confirm the presence of the detected objects in the one or more zones of the subset of zones includes:
controlling the searchlight system to track a movement of the weather radar so as to examine a same zone as the weather radar.

5. The method of claim 1, wherein the electro-optical and imaging system includes a camera system, and
the controlling the electro-optical and imaging system of the vehicle to examine the subset of zones to identify and confirm the presence of the detected objects in the one or more zones of the subset of zones includes:
controlling a display of the vehicle to display a radar image based on the volumetric radar data,
receiving a user input that selects a first detected object in a first zone, and
controlling the camera system to examine the first zone.

6. The method of claim 5, wherein the receiving the confirmation that a detected object of the detected objects is present in the one or more zones of the subset of zones includes at least one of:
processing a camera image generated by the camera system to confirm the presence of the detected object, or
transmitting the camera image to the display of the vehicle and receiving a second user input to confirm the presence of the detected object.

7. The method of claim 1, wherein the performing the action to update the vehicle system in response to receiving the confirmation includes:
updating a database of the vehicle, and
transmitting an instruction to another vehicle to travel to the detected object in the one or more zones of the subset of zones, wherein the another vehicle performs a second action with respect to the detected object and transmits a result and/or images to the vehicle, and
wherein the method further includes:
receiving the result and/or the images from the another vehicle, and
displaying the result and/or the images on a display of the vehicle.

8. A system for detecting and confirming objects using a radar system and an electro-optical and imaging system of a vehicle, the system comprising:
a memory storing instructions; and
a processor executing the instructions to perform a process including:
obtaining volumetric radar data, the volumetric radar data being produced by the radar system of the vehicle for zones of a scanned area;
analyzing the volumetric radar data to detect objects in a subset of zones from among the zones of the scanned area;
controlling the electro-optical and imaging system of the vehicle to examine the subset of zones to identify and confirm the presence of the detected objects in one or more zones of the subset of zones;
receiving a confirmation that a detected object of the detected objects is present in the one or more zones of the subset of zones; and
performing an action to update a vehicle system in response to receiving the confirmation.

9. The system of claim 8, wherein the volumetric radar data includes time slices of the zones of the scanned area, and the zones are based on ranges and azimuth angles of reflection signals received by the radar system.

10. The system of claim 9, wherein the analyzing the volumetric radar data to detect the detected objects in the subset of zones includes:
tracking the detected objects over a period of time that includes at least two time slices of the time slices, and
estimating a movement direction and speed of the detected objects.

11. The system of claim 8, wherein the electro-optical and imaging system includes a searchlight system, and
the controlling the electro-optical and imaging system of the vehicle to examine the subset of zones to identify and confirm the presence of the detected objects in the one or more zones of the subset of zones includes:
controlling the searchlight system to track a movement of the weather radar so as to examine a same zone as the weather radar.

12. The system of claim 8, further comprising: a display, and
wherein the electro-optical and imaging system includes a camera system, and
the controlling the searchlight system of the vehicle to examine the subset of zones to identify and confirm the presence of the detected objects in the one or more zones of the subset of zones includes:
controlling the display of the vehicle to display a radar image based on the volumetric radar data;
receiving a user input that selects a first detected object in a first zone; and
controlling the camera system to examine the first zone.

13. The system of claim 12, wherein the receiving the confirmation that a detected object of the detected objects is present in the one or more zones of the subset of zones includes at least one of:
processing a camera image generated by the camera system to confirm the presence of the detected object; or
transmitting the camera image to the display and receiving a second user input to confirm the presence of the detected object.

14. The system of claim 8, further comprising: a display, and
wherein the performing the action to update the vehicle system in response to receiving the confirmation includes:
updating a database of the vehicle; and
transmitting an instruction to another vehicle to travel to the detected object in the one or more zones of the subset of zones, wherein the another vehicle performs a second action with respect to the detected object and transmits a result and/or images to the vehicle, and
wherein the process further includes:
receiving the result and/or the images from the another vehicle, and
displaying the result and/or the images on the display.

15. A non-transitory computer-readable medium storing instructions that, when executed by a processor, cause the processor to perform a method for detecting and confirming objects using a radar system and an electro-optical and imaging system of a vehicle, the method comprising:
obtaining volumetric radar data, the volumetric radar data being produced by the radar system of the vehicle for zones of a scanned area;
analyzing the volumetric radar data to detect objects in a subset of zones from among the zones of the scanned area;
controlling the electro-optical and imaging system of the vehicle to examine the subset of zones to identify and confirm the presence of the detected objects in one or more zones of the subset of zones;
receiving a confirmation that a detected object of the detected objects is present in the one or more zones of the subset of zones; and
performing an action to update a vehicle system in response to receiving the confirmation.

16. The non-transitory computer-readable medium of claim 15, wherein the volumetric radar data includes time slices of the zones of the scanned area;
the zones are based on ranges and azimuth angles of reflection signals received by the radar system; and
the analyzing the volumetric radar data to detect the detected objects in the subset of zones includes:
tracking the detected objects over a period of time that includes at least two time slices of the time slices, and
estimating a movement direction and speed of the detected objects.

17. The non-transitory computer-readable medium of claim 15, wherein the electro-optical and imaging system includes a searchlight system, and
the controlling the searchlight system of the vehicle to examine the subset of zones to identify and confirm the presence of the detected objects in the one or more zones of the subset of zones includes:
controlling the searchlight system to track a movement of the weather radar so as to examine a same zone as the weather radar.

18. The non-transitory computer-readable medium of claim 15, wherein the electro-optical and imaging system includes a camera system; and
the controlling the searchlight system of the vehicle to examine the subset of zones to identify and confirm the presence of the detected objects in the one or more zones of the subset of zones includes:
controlling a display of the vehicle to display a radar image based on the volumetric radar data,
receiving a user input that selects a first detected object in a first zone, and
controlling the camera system to examine the first zone.

19. The non-transitory computer-readable medium of claim 18, wherein the receiving the confirmation that a detected object of the detected objects is present in the one or more zones of the subset of zones includes at least one of:
processing a camera image generated by the camera system to confirm the presence of the detected object, or
transmitting the camera image to the display of the vehicle and receiving a second user input to confirm the presence of the detected object.

20. The non-transitory computer-readable medium of claim 15, wherein the performing the action to update the vehicle system in response to receiving the confirmation includes:
updating a database of the vehicle, and
transmitting an instruction to another vehicle to travel to the detected object in the one or more zones of the subset of zones, wherein the another vehicle performs a second action with respect to the detected object and transmits a result and/or images to the vehicle, and
wherein the method further includes:
receiving the result and/or the images from the another vehicle, and
displaying the result and/or the images on a display of the vehicle.
